(19) United States
(12) Patent Application Publication
(10) Pub. No.: US 2016/0096058 A1
(43) Pub. Date: Apr. 7, 2016

(54) Rocking Lever Platform Power Conversion Apparatus

(71) Applicant: Jianhan Lin, Marlton, NJ (US)

(72) Inventor: Jianhan Lin, Marlton, NJ (US)

(21) Appl. No.: 14/968,872

(22) Filed: Dec. 14, 2015

Related U.S. Application Data
(63) Continuation-in-part of application No. PCT/US14/41797, filed on Jun. 10, 2014.
(60) Provisional application No. 61/834,963, filed on Jun. 14, 2013.

(51) Int. Cl. A63B 21/005; A63B 21/00

(52) U.S. Cl. CPC A63B 21/0055; A63B 21/0004; A63B 21/4045; A63B 21/4035

(57) ABSTRACT

A multi-functional apparatus, more specifically, the present invention is an exercise machine which is designed to elevate the user's heart rate, strength muscle and joint power and stretch the whole body by providing the user with resistance along a line of motion which by nature engages a plurality of muscle groups simultaneously. In addition, the present invention also embodies the machine being used as a hand powered water pump, air pump, and or electric generator.

The current application is a Continuation-In-Part of the Patent Cooperation Treaty application serial number PCT/US2014/041797, which claims a priority to the U.S. Provisional Patent application Ser. No. 61/834,963 filed on Jun. 14, 2013.

### FIELD OF THE INVENTION

The present invention relates generally to an exercise machine. More specifically, the present invention is an exercise machine which is designed to elevate the user's heart rate, strength muscle and joint power and stretch the whole body by providing the user with resistance along a line of motion which by nature engages a plurality of muscle groups simultaneously. In addition, the present invention also embodies the machine being used as a hand powered water pump, air pump, and or electric generator.

### BACKGROUND OF THE INVENTION

It is a principal object of the invention to provide the general population with a convenient and advanced way to exercise as well as achieve the maximum health advantage from training courses. The simple rocking device is simple, easy, safe to operate, and yet is small and convenient enough to fit in small spaces resulting in an exercise machine which is readily available at any moment and in any room. By perfectly combining the human body's bio-structure, the present invention provides an exercise machine which targets all of the major muscle groups in one simple motion. One can simply repeat the rocking motion, moving the shaft left and right in circles, and get all those major muscle groups engaged with the same single device. Additionally, one can pump up a single or a couple of those muscle groups again and again with the same single device as well. Through the use of the present invention achieving a healthy body is simpler and more convenient. The device can increase your strength, speed, and flexibility while simultaneously yielding a good workout. The present invention is easy to use for various body types, young or old. The device can provide you with the gentle strength and mild movement required to start a recovery at old age or unhealthy condition. The device provides you with a new way to exercise, one can even read while working out. And the device provides you a new way to exercise while you are watching TV. With the present invention there is no excuse to become a couch potato and use the “no time for fitness” excuse.

It is an additional object of the present invention to provide an environmental friendly, yet convenient and advanced way for a human to power a water pump in needed areas, or simply pump water out from the flooding basement in the occurrence of power outage from any disaster events, or simply to pump water up to a water tower to be stored as potential energy. Another related object of the present invention is to provide an advanced way for humans to power a pump which increases the pressure air in a storage tank from the daily fitness actions. One can use the pressure air from the storage tank to power tools, or to fill the flat tires of cars. Another important object of the present invention is to provide an environmental friendly, yet convenient and advanced way for humans to generate electricity in areas without power. Furthermore, in the case of power outage from any disaster events, the device can provide temporary relief as needed.

### BRIEF DESCRIPTION OF THE DRAWINGS

FIG. 1 is an isometric view of one embodiment of the present invention, a power resistance rocking device for fitness exercises, water pumping, and air pumping, illustrating the general structure here with two shock absorbers.

FIG. 2 is a side elevation view of the power resistance rocking device.

FIG. 3 is a sectional side view of a handle structure on a rocking lever for the present invention.

FIG. 4 is a principle function front view of the rocking device, illustrating the principle leftward-rightward or forward-backward rocking span of the present invention.

FIG. 5 is an exploded view of the rocking device.

FIG. 6 is another embodiment of the present invention, a modification of the previous rocking device, FIG. 1 for a different size of power resistance devices, shock absorbers, water pumps and air pumps.

FIG. 7 is an illustrating front view of the rocking devices with additional rock levers and connection rods to form a group performance power station as needed.

FIG. 8 is an illustrating top view of the rocking devices with additional rock levers, additional connection rods and premier personal arrangement as will to form a group power station as needed.

FIG. 9 is an isometric view of another embodiment of the present invention, including two tiers of belt and roller transmission to transfer the rocking movement into a one way rotation and pump up to a higher RPM for electricity power generation.

FIG. 10 is a principle function front view of the rocking power station and a fragmentary, enlarged section view of the connection from rocking lever to transmission belt.

FIG. 11 is a partial isometric exploded view of the power rocking device.

FIG. 12 is a rear isometric view of the present invention in the folded state.

FIG. 13 is a front isometric view of the present invention in the folded state.

FIG. 14 is a side view of the present invention in the folded state.

FIG. 15 is a side view of the present invention in the unfolded state.

FIG. 16 is a top view of the present invention in the unfolded state.

FIG. 17 is a front isometric view of the present invention in the unfolded state.

FIG. 18 is a front view of the present invention depiction the range of motion.

FIG. 19 is a side view of the present invention depiction the range of motion.

### DETAIL DESCRIPTIONS OF THE INVENTION

All illustrations of the drawings are for the purpose of describing selected versions of the present invention and are not intended to limit the scope of the present invention.

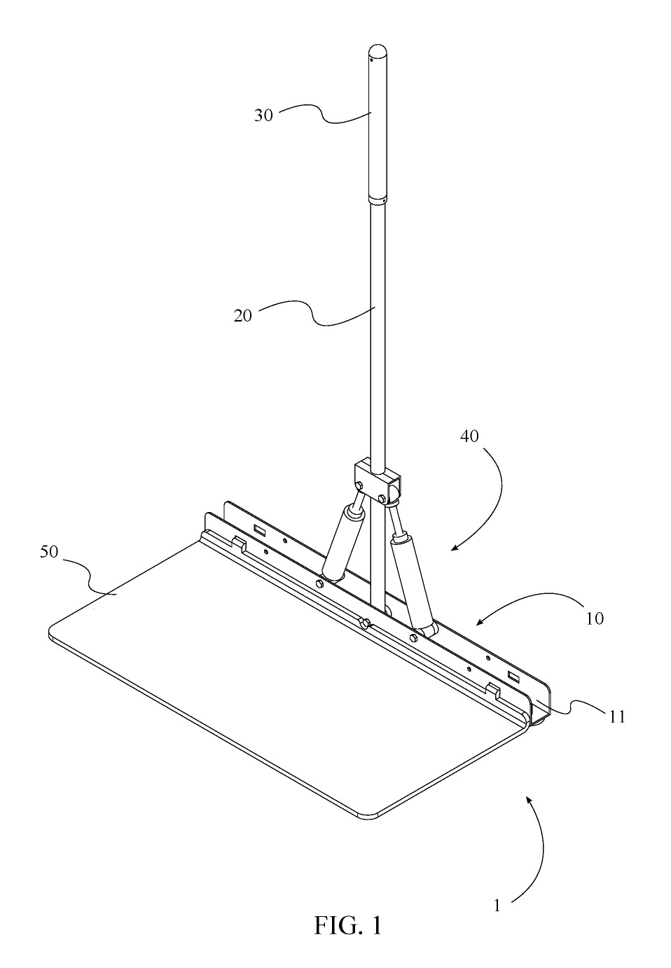

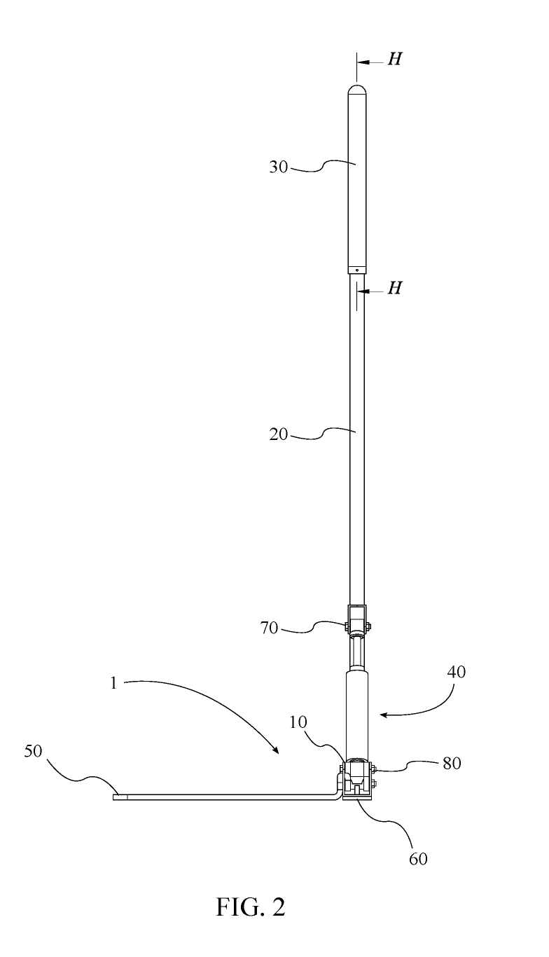

The present invention is a reciprocating human-powered rocker that can be adapted for use for fitness, pumping or electricity generation purposes. Referring to FIGS. 1-5, the present invention generally comprises a main base 1, a rocking lever 20, and a power conversion system 40. The main base 1 comprises a lever attachment frame 10 and an anchoring platform 50. The lever attachment frame 10 is connected adjacent to the anchoring platform 50. A lower end 22 of the rocking lever 20 is pivotally connected to the lever attachment frame 10. The power conversion system 40 is operatively engaged between the rocking lever 20 and the lever attachment frame 10, wherein the power conversion system 40 converts kinetic energy from motion of the rocking lever 20 into non-kinetic energy. The power conversion system 40 is used in conjunction with the rocking lever 20 to accomplish energy conversion. Applications of energy conversion may include, but are not limited to, resistance mechanisms for physical fitness purposes, fluid pumping, electricity generation, or other purposes.

In the preferred embodiment of the present invention, the lever attachment frame 10 is a C-channel 11. The C-channel 11 is made of thick gauge metal and has all mount holes and cuts ready for all necessary connections. The C-channel 11 is the best fit for the application in this case to suit all the different pivot axle mount positions. The channel provides additional mounting holes to accommodate the addition of power resistance devices without the need for extra mounting brackets and or welding.

In the preferred embodiment of the present invention, the anchoring platform 50 is flat. The anchoring platform 50 may also be called a step board upon which a user stands while operating the rocking lever 20. The anchoring platform 50 can be made of aluminum plate, durable fiberglass, or a combination of other materials such as steel. It provides a perfect stepping board for many foot positions and foot workouts in conjunction with the present invention. The step board supports and holds down the lever attachment frame 10 during the operation of the present invention as otherwise the base might flip in response to the rocking motion of the rocking lever 20. It may have some texture surface on the top of the board to make both for better grip and for increased comfort of the board.

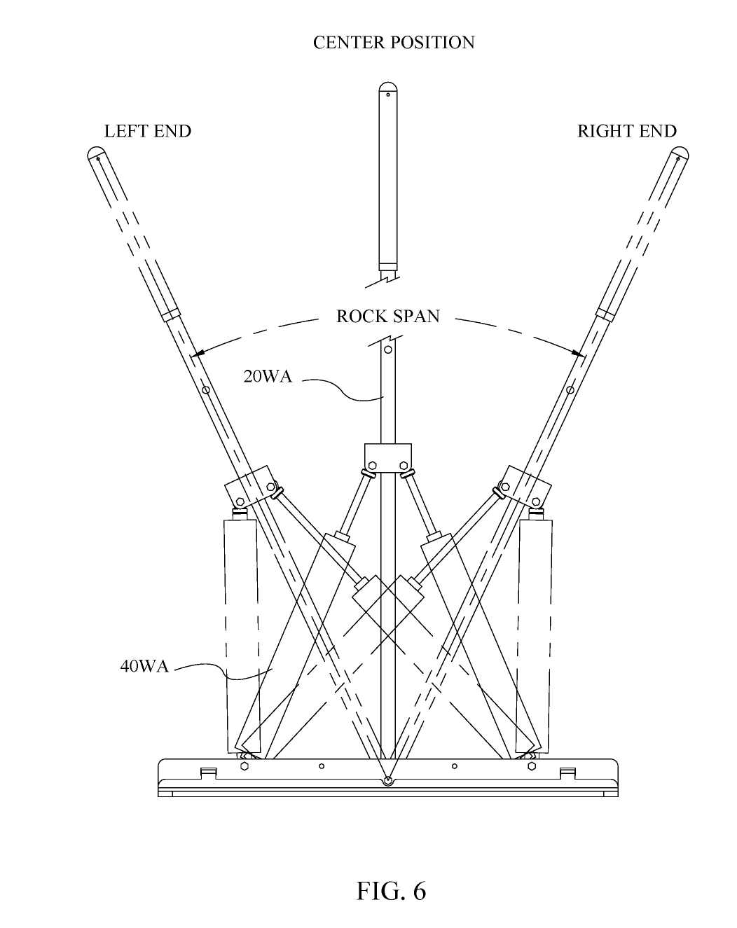

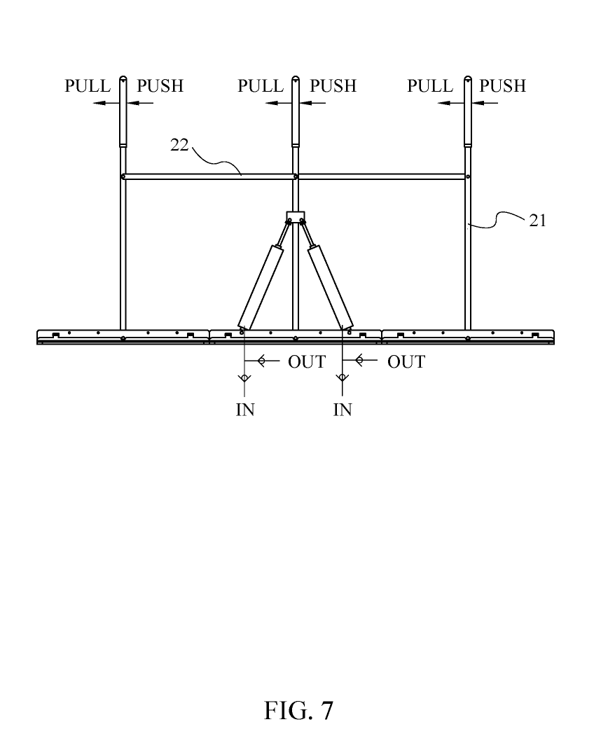

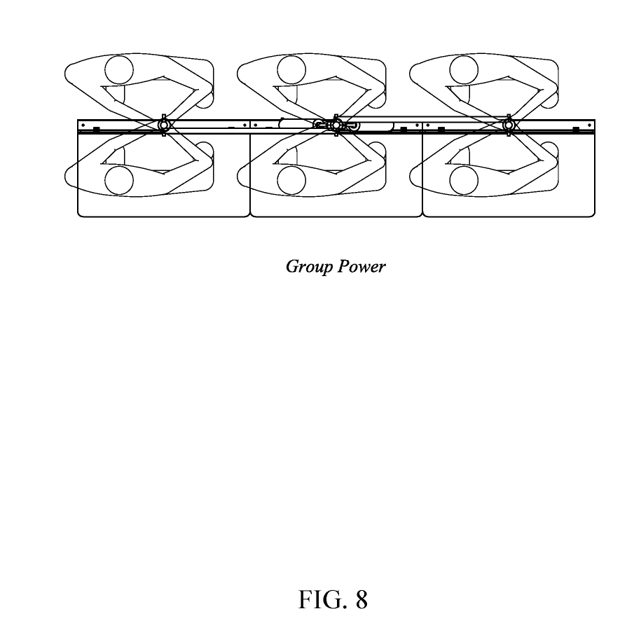

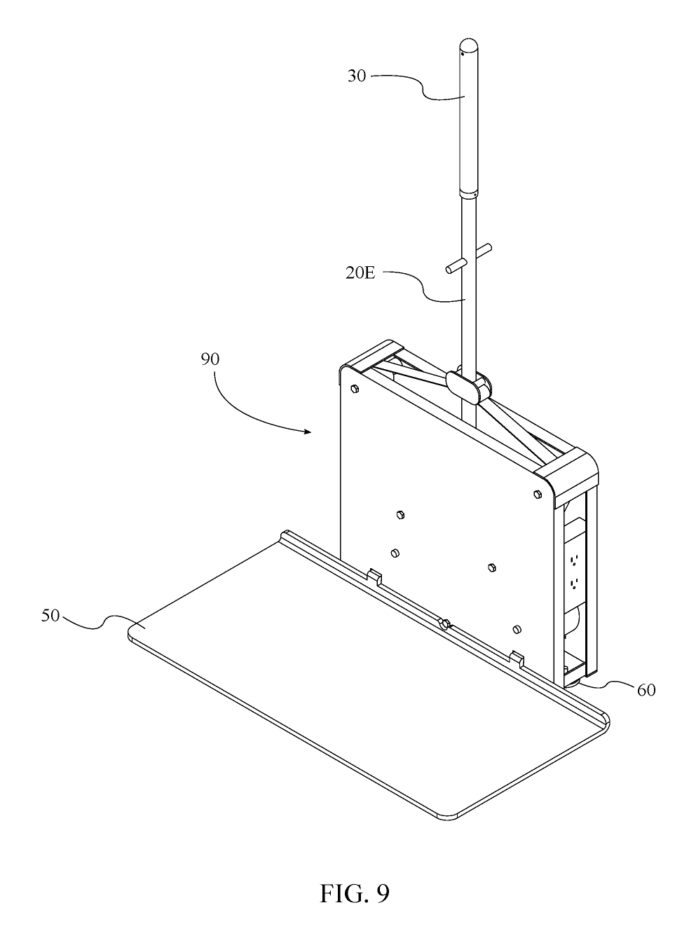

The rocking lever 20 is preferably made of steel pipe. It has numbers of different structures for many options. Illustrating in FIG. 6 is 20 WA for a large size of power resistance devices, and 40WA, FIG. 7-8 is for an additional rocker and FIG. 9 is 20E for a portable power generator.

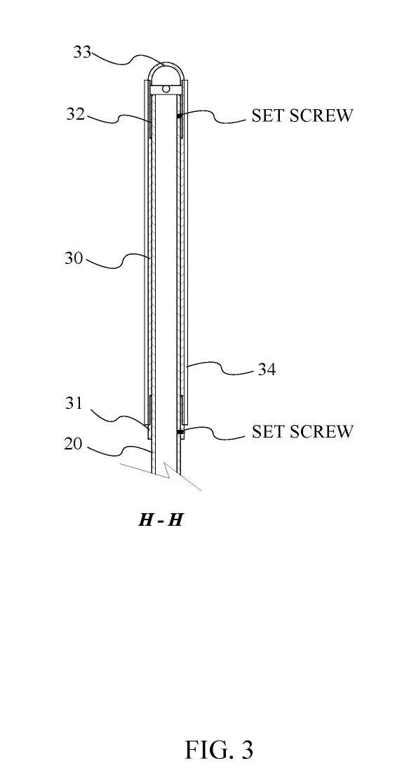

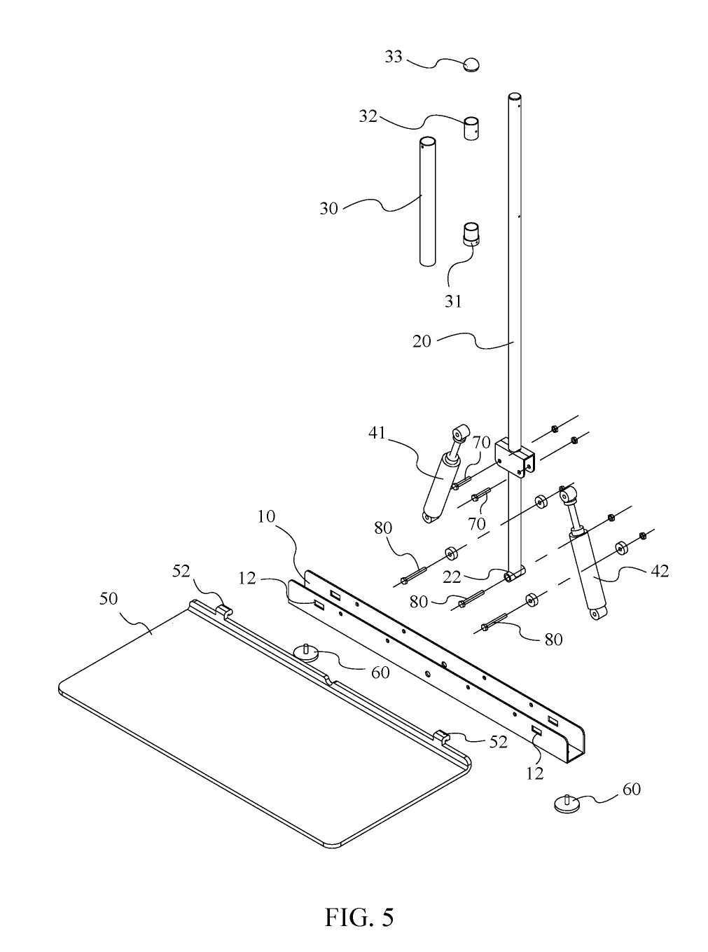

Referring to FIGS. 3 and 5, the handle 30 is connected to the rocking lever 20 opposite the lower end 22. Additionally, an ergonomic handle wrap pad 34 is connected concentrically around the handle 30, so that the handle 30 is covered with soft wrap pad 34 to offer a bio-friendly touch. Additionally, sensors may be attached to or within the handle 30, so that bio-metric readings can be achieved to monitor and analyze one's workout bio-conditions and bio-performances. In one embodiment, the sensors are electronically connected to a display monitor; the display monitor analyzes the information from the sensors and displays said information on the electronic visual display to the user. It has a structure to position between and rotates around two bushings, 31 and 32 on the top end of rocking lever 20. The handle 30 is additionally plugged with a round top cover 33.

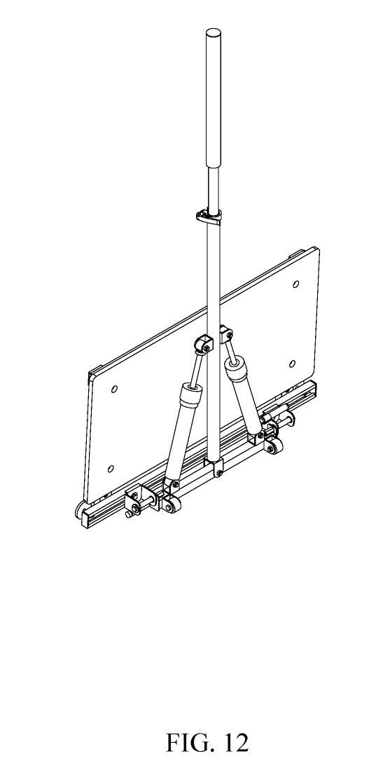

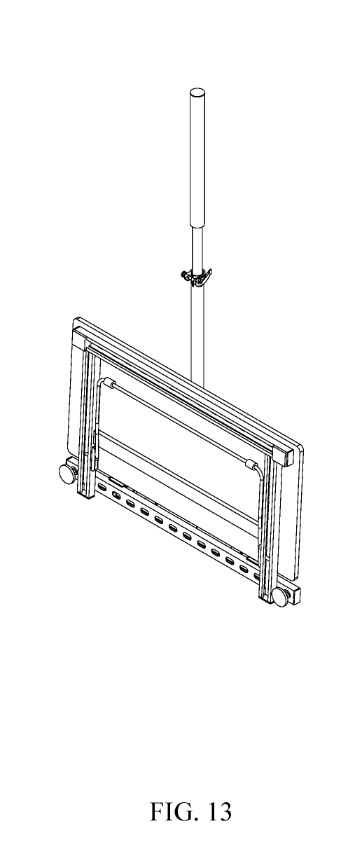

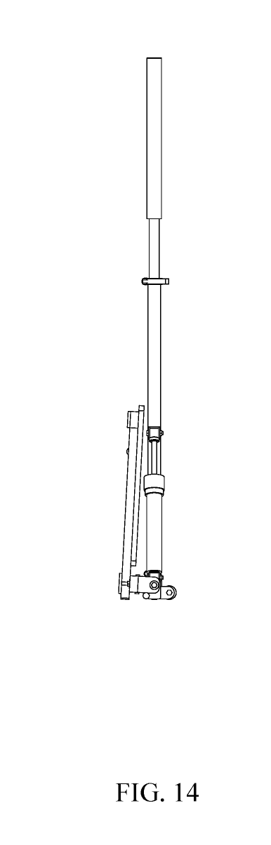

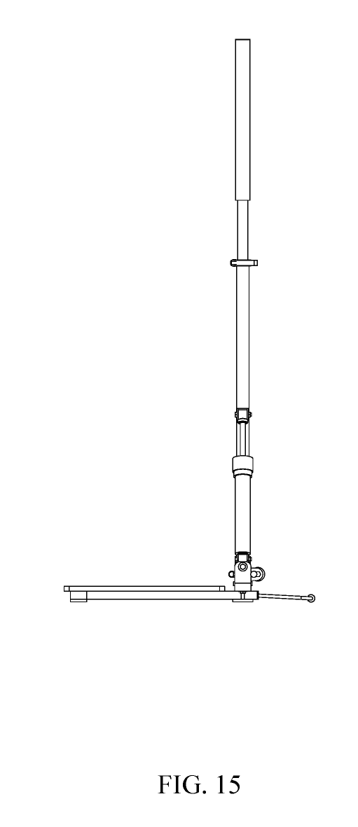

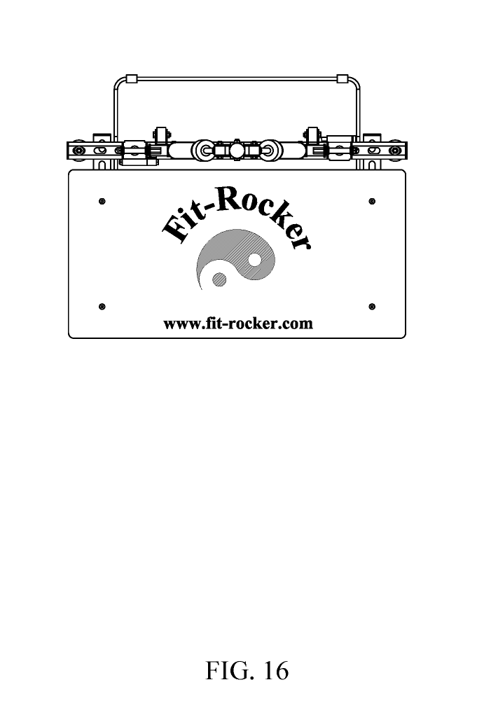

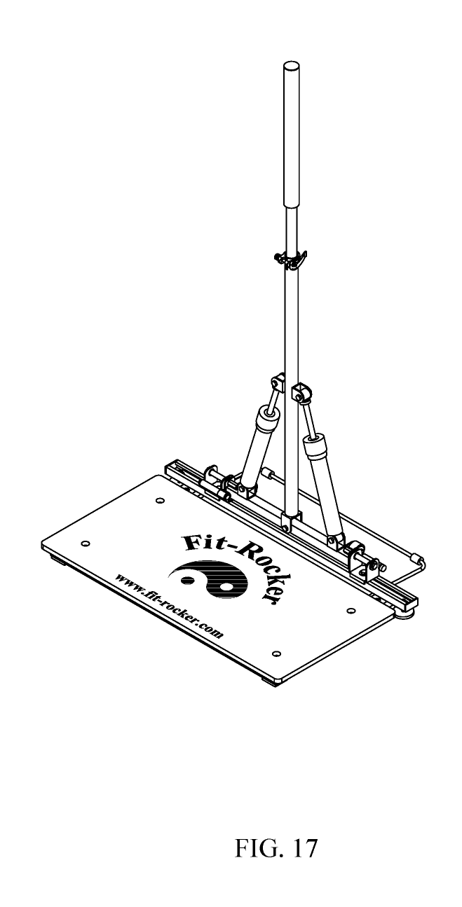

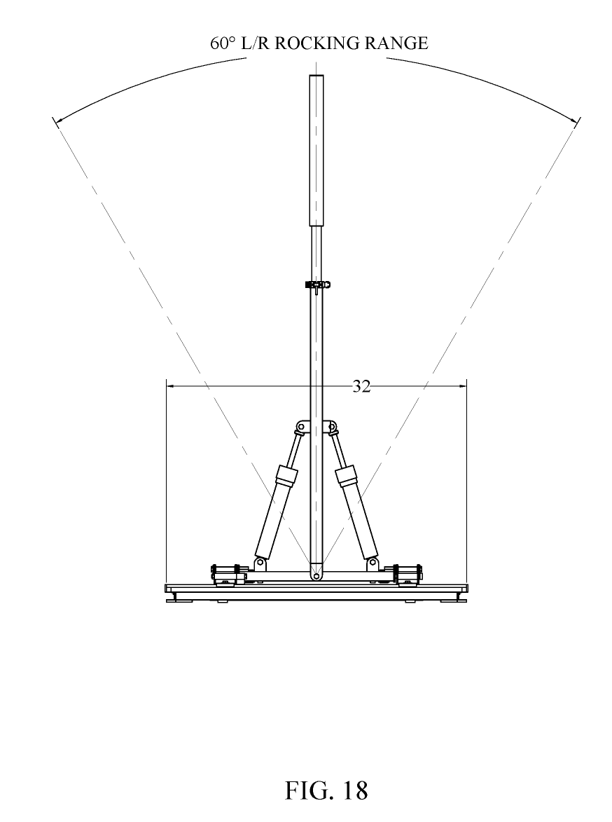

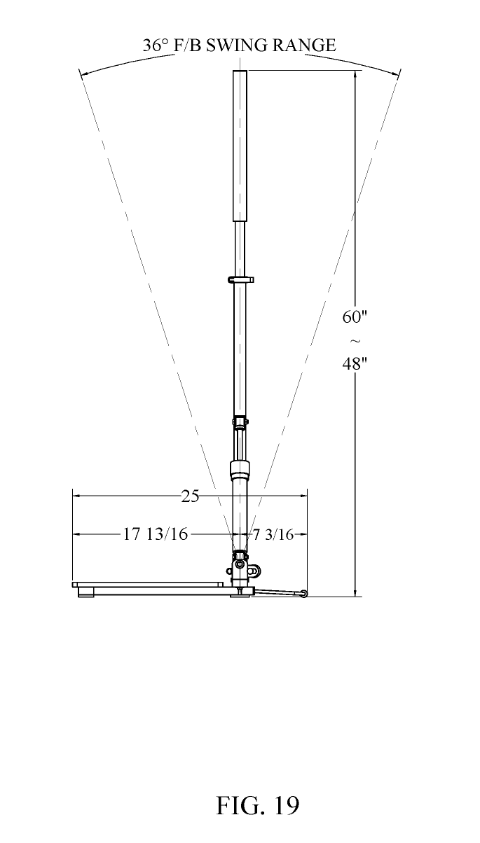

The connection between the anchoring platform 50 and the lever attachment frame 10 is as follows. The anchoring platform 50 comprises a plurality of tabs 52, spaced along one edge of the anchoring platform 50. The lever attachment frame 10 comprises a plurality of slots 12 in the wall of the C-channel 11. The plurality of tabs 52 are removably inserted into the plurality of slots 12 in order to attach the anchoring platform 50 to the lever attachment frame 10. It is further contemplated, however, that any other relevant and useful means may be utilized to connect the anchoring platform 50 and the lever attachment frame 10, such as, but not limited to, hinges, screws, snaps, or other means. An embodiment utilizing hinges to connect the lever attachment frame 10 and the anchoring platform 50 is shown in FIGS. 12-19. Furthermore, the anchoring platform 50 and the lever attachment frame 10 may be integrally connected to each other in alternate embodiments; however, it is desirable for the anchoring platform 50 to be able to fold up or detach from the lever attachment frame 10 for portability. The present invention additionally comprises a plurality of leveling legs 60. The plurality of leveling legs 60 are attached to an underside of the lever attachment frame 10 opposite the rocking lever 20.

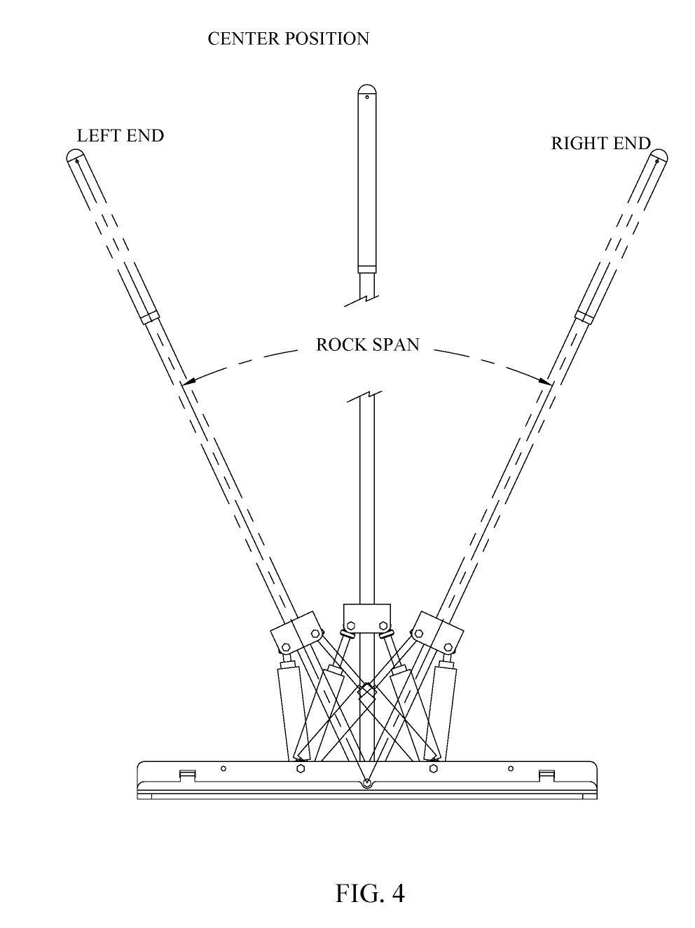

The power conversion system 40 preferably utilizes power resistance pumping devices. 40 and 40WA in FIG. 6 are key power resistance devices in the present invention, which can be power shock absorbers, water pumps, or pressure air pumps. They can be one way or two way power resistance shock absorbers. They can be one way or two way water pumps or pressure air pumps. They can be many different sizes and many options. They can be adjustable. Referring to FIGS. 4 and 6, the drawings show how shock absorbers, water pumps and pressure air pumps achieve their one way or two way pumping actions from a simple human rocking action. By adjusting the pressure valves for adjustable shock absorbs, or simply switch to variable sizes of shock absorbs, water pumps and air pumps, one can adjust to get desired power force and speed applying to the rocking handle 30.

In the preferred embodiment of the present invention, the power conversion system 40 comprises a first shock absorber 41 and a second shock absorber 42. The first shock absorber 41 is pivotally connected between the lever attachment frame 10 and the rocking lever 20, and the second shock absorber 42 is pivotally connected between the lever attachment frame 10 and the rocking lever 20 opposite the first shock absorber 41. The first shock absorber 41 and the second shock absorber 42 may be any relevant and useful type of damper, dashpot or other mechanism or device which resists motion. In alternate embodiments, the power conversion system 40 may be a water pump, a pressure air pump, or an electrical generation system 90.

The rocking lever 20, the first shock absorber 41, and the second shock absorber 42 are each pivotally connected within the C-channel 11 by one of a plurality of pivot axles 80. The first shock absorber 41 and the second shock absorber 42 are positioned opposite each other about the rocking lever 20 within the C-channel 11, and the first shock absorber 41 and the second shock absorber 42 are pivotally connected to the rocking lever 20 between the lower end 22 of the rocking lever 20 and a handle 30 of the rocking lever 20. The first shock absorber 41 and the second shock absorber 42 are connected to the rocking lever 20 by a pair of pivot axles 70.

Referring to FIGS. 7-8, multiple instances of the present invention may be combined to for use by multiple individuals at once. Thus, a secondary rocking lever 21 20 is pivotally connected within the C-channel 11, similar to the rocking lever 20. The C-channel 11 and the anchoring platform 50 are extended further than in the singular embodiment in order to accommodate space for multiple users. The rocking lever 20 and the secondary rocking lever 21 are separated from each other along the C-channel 11 by enough distance to allow users to simultaneously engage with the multiple lever embodiment comfortably. A connection rod 22 is rotatably connected between the rocking lever 20 and the secondary rocking lever 21 between the lower end 22 and the handle 30 of the rocking lever 20 and the secondary rocking lever 21, thus coupling the rocking motion of the rocking lever 20 and the secondary rocking lever 21. This alternate embodiment of the present invention can be used by a plurality of people to yield a group fitness activity, or it can be used to pump water or air in areas where it is needed, while involving as many people as possible for superior pumping power. It can also be placed in a playground for play and fun as well.

FIGS. 9-11 shows another alternate embodiment of a portable power generator. A user can pull and push the rocking lever 20 to pull the belt transmission 91 and generate electricity from a DC generator. The anchoring platform 50 may be folded up for portability in order to carry the power box to any location.

In an alternate embodiment where the power conversion system 40 is an electrical generation system 90, the electrical generation system 90 comprises a belt transmission 91 and an electrical generator 94. The rocking lever 20 is operatively coupled to the electrical generator 94 by the belt transmission 91, wherein pivoting motion of the rocking lever 20 causes the belt transmission 91 to turn an input shaft of the electrical generator 94 to generate electricity.

The belt transmission 91 comprises a transmission belt 92 and a plurality of guide rollers 93. The transmission belt 92 is connected to the rocking lever 20 between the lower end 22 and the handle 30 by at least one trap rod. In the preferred embodiment, two trap rods are utilized, so that the transmission belt 92 is connected to both the opposite sides of the rocking lever 20. The transmission belt 92 is operatively engaged between the rocking lever 20 and the electrical generator 94 through the plurality of guide rollers 93. Additionally, in the preferred embodiment at least one flywheel 95 is operatively engaged with the belt transmission 91. Each flywheel 95 is preferably concentrically engaged with one of the plurality of guide rollers 93 or any other rotational component of the belt transmission 91.

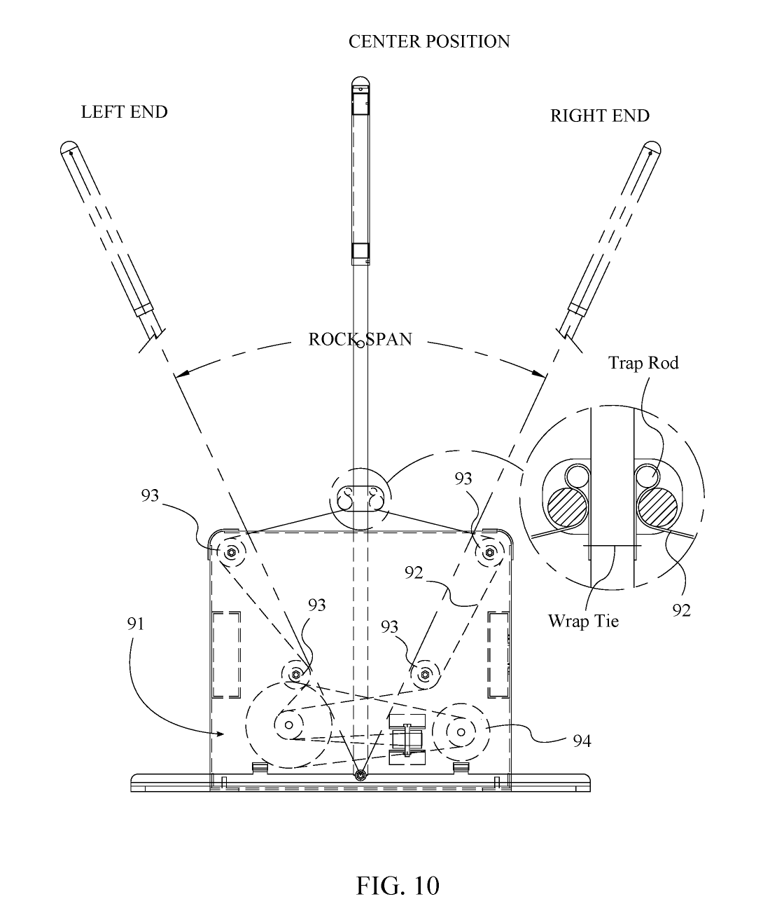

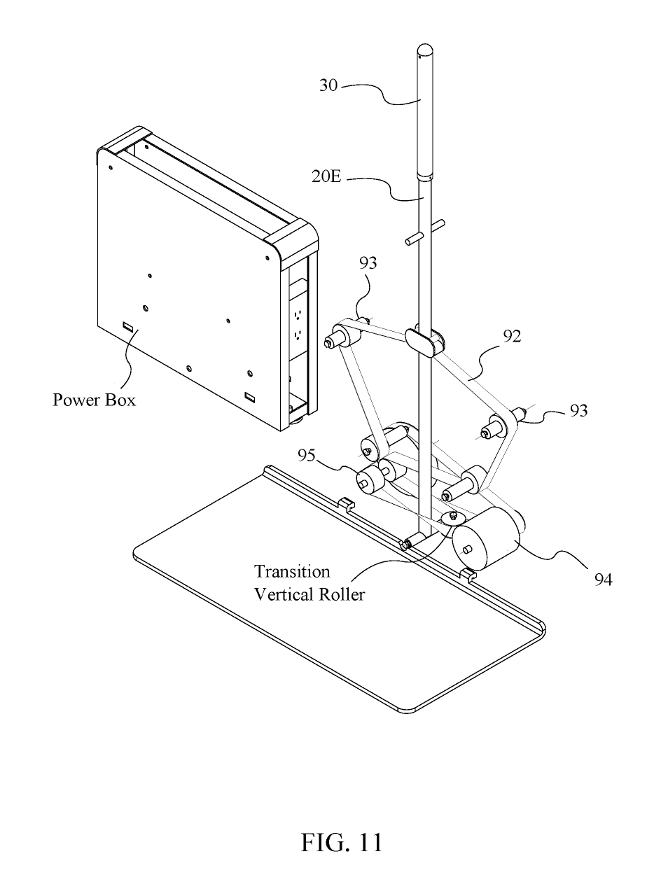

FIGS. 10-11, show the rocking lever 20 pulling the belt from left or right, back or forth and transferring the rocking force into a one way rolling force through the first tier transmission belt, guide rollers and flywheels. Subsequently, a higher RPM is achieved through a second tier transmission belt from the first tier transmission belt to a DC electric generator. By connecting the DC current to an inverter on the power box, one can transfer the power into the desired current and voltage and use the power directly in the field or charge batteries and store the power energy for later usage. The anchoring platform 50 needs only to be modified to mount with the power box. It needs to be able to be fold into a smaller size to accommodation with the portable power box. It can be attached with two rollers. And when it is folded up, the power box can be pulled and moved on those two rollers.

The housing of the power box is composed of sheet metals or other durable materials and structured to support all axles and the DC generator. The power box is connected with a power inverter and a charger. It may carry batteries as well. Additionally, the rocking lever 20 can be broken into two pieces or folded down to a short size for easier carrying of the power box.

Although the invention has been explained in relation to its preferred embodiment, it is to be understood that many other possible modifications and variations can be made without departing from the spirit and scope of the invention.

What is claimed is:

1. A rocking lever platform power conversion apparatus comprises:
a main base comprising a lever attachment frame and an anchoring platform;
a rocking lever;
a power conversion system;
the lever attachment frame being connected adjacent to the anchoring platform;
a lower end of the rocking lever being pivotally connected to the lever attachment frame; and
the power conversion system being operatively engaged between the rocking lever and the lever attachment frame, wherein the power conversion system converts kinetic energy of the rocking lever into non-kinetic energy.

2. The rocking lever platform power conversion apparatus as claimed in claim 1 comprises:
the power conversion system comprises a first shock absorber and a second shock absorber;
the first shock absorber being pivotally connected between the lever attachment frame and the rocking lever; and
the second shock absorber being pivotally connected between the lever attachment frame and the rocking lever opposite the first shock absorber.

3. The rocking lever platform power conversion apparatus as claimed in claim 1 comprises:
the lever attachment frame being a C-channel;
the rocking lever, a first shock absorber of the power conversion system and a second shock absorber of the power conversion system being pivotally connected within the C-channel by a plurality of pivot axles;
the first shock absorber and the second shock absorber being positioned opposite each other about the rocking lever within the C-channel; and
the first shock absorber and the second shock absorber being pivotally connected to the rocking lever between the lower end of the rocking lever and a handle of the rocking lever.

4. The rocking lever platform power conversion apparatus as claimed in claim 1 comprises:
a handle; and
the handle being connected to the rocking lever opposite the lower end.

5. The invention as claimed in claim 4 comprises:
a handle wrap pad; and
the handle wrap pad being connected concentrically around the handle.

6. The rocking lever platform power conversion apparatus as claimed in claim 1, wherein the anchoring platform is flat.

7. The rocking lever platform power conversion apparatus as claimed in claim 1 comprises:
the anchoring platform comprises a plurality of tabs;
the lever attachment frame comprises a plurality of slots; and
the plurality of tabs being removably inserted into the plurality of slots.

8. The rocking lever platform power conversion apparatus as claimed in claim 1 comprises:
the power conversion system being a water pump.

9. The rocking lever platform power conversion apparatus as claimed in claim 1 comprises:
the power conversion system being a pressure air pump.

10. The rocking lever platform power conversion apparatus as claimed in claim 1 comprises:
the power conversion system being an electrical generation system.

11. The rocking lever platform power conversion apparatus as claimed in claim 10 comprises:
the electrical generation system comprises a belt transmission and an electrical generator; and
the belt transmission being operatively engaged between the rocking lever and the electrical generator, wherein pivoting motion of the rocking lever causes the belt transmission to turn an input shaft of the electrical generator in order to generate electricity.

12. The rocking lever platform power conversion apparatus as claimed in claim 11 comprises:
the belt transmission comprises a transmission belt and a plurality of guide rollers;
the transmission belt being connected to the rocking lever between the lower end and the handle by a trap rod; and
the transmission belt being operatively engaged between the rocking lever and the electrical generator through the plurality of guide rollers.

13. The rocking lever platform power conversion apparatus as claimed in claim 11 comprises:
at least one flywheel being operatively engaged with the belt transmission.

14. The rocking lever platform power conversion apparatus as claimed in claim 1 comprises:
a secondary rocking lever;
a connection rod;
the secondary rocking lever being pivotally connected within a C-channel of the lever attachment frame;
the rocking lever and the secondary rocking lever being separated from each other along the C-channel; and
the connection rod being connected between the rocking lever and the secondary rocking lever between the lower end and the handle of the rocking lever and the secondary rocking lever.

15. The rocking lever platform power conversion apparatus as claimed in claim 1 comprises:
a plurality of leveling legs; and
the plurality of leveling legs being attached to an underside of the lever attachment frame opposite the rocking lever.
